(19) United States
(12) Patent Application Publication
(10) Pub. No.: US 2023/0115156 A1
(43) Pub. Date: Apr. 13, 2023

(54) Systems, Devices, and/or Methods for Making Cast Articles

(71) Applicant: Alexander Lopez, Richmond, VA (US)

(72) Inventor: Alexander Lopez, Richmond, VA (US)

(21) Appl. No.: 17/495,873

(22) Filed: Oct. 7, 2021

(51) Int. Cl. B28B 3/08; B28B 11/08; B28B 7/34; B65D 1/36

(52) U.S. Cl. CPC B28B 3/083; B28B 11/0845; B28B 7/348; B65D 1/36; B33Y 80/00

(57) ABSTRACT

Certain exemplary embodiments can provide a method comprising pouring a castable material into a mold to form a dish. The method comprises pressing a first object into the castable material thereby forming a first cavity in the dish. The method comprises pressing a second object into the castable material thereby forming a second cavity in the dish.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a dish 1000;

FIG. 2 is a perspective view of dish 1000;

FIG. 3 is a perspective view of a portion of dish 1000;

FIG. 4 is a perspective view of an exemplary embodiment of a system 4000;

FIG. 5 is a perspective view of an exemplary embodiment of a system 5000;

FIG. 6 is a perspective view of an exemplary embodiment of an object negative 6000;

FIG. 7 is a perspective view of an exemplary embodiment of an object negative 7000;

FIG. 8 is a perspective view of an exemplary embodiment of an object negative 8000;

FIG. 9 is a flowchart of an exemplary embodiment of a method 9000; and

FIG. 10 is a flowchart of an exemplary embodiment of a method 10000.

### DETAILED DESCRIPTION

Certain exemplary embodiments can provide a method comprising pouring a castable material into a dish mold to form a dish. In certain exemplary embodiments, the dish mold can be cast or carved from a plastic material. The method comprises pressing a first object into the castable material thereby forming a first cavity in the dish. The method comprises pressing a second object into the castable material thereby forming a second cavity in the dish.

In certain exemplary embodiments, the castable material can comprise sand and cement (e.g., white sand and white cement). In certain exemplary embodiments, small stones can be added to the castable material to improve a finished appearance of the dish. In certain exemplary embodiments, pigments can be added to the castable material to create custom colored dishes.

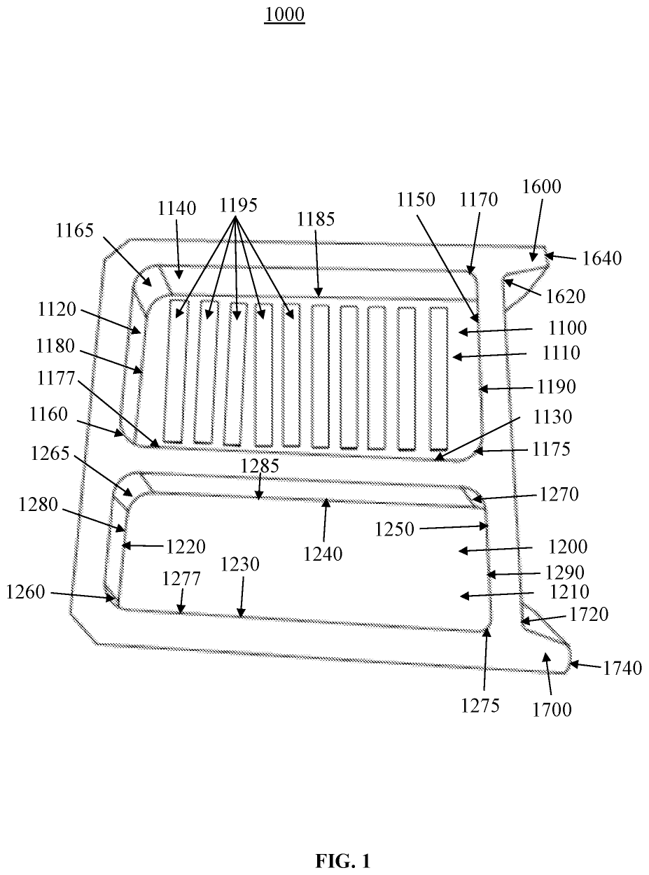

FIG. 1 is a perspective view of an exemplary embodiment of a dish 1000. Dish 1000 defines a first cavity 1100 and a second cavity 1200. Each of first cavity 1100 and the second cavity 1200 has a bottom (bottom 1110 of first cavity 1100 and bottom 1210 of second cavity 1200) and four edges (first edge 1120, second edge 1130, third edge 1140, and fourth edge 1150 of first cavity 1100; and first edge 1220, second edge 1230, third edge 1240, and fourth edge 1250 of second cavity 1200).

A junction between the bottom and each four edges of each of the first cavity (first junction 1177, second junction 1180, third junction 1185, and fourth junction 1190 of first cavity 1100) and the second cavity (first junction 1277, second junction 1280, third junction 1285, and fourth junction 1290 of second cavity 1200) has a rounded surface.

Each junction between each the four edges of each of the first cavity (first junction 1160, second junction 1165, third junction 1170, and fourth junction 1175 of first cavity 1100) and the second cavity (first junction 1260, second junction 1265, third junction 1270, and fourth junction 1275 of second cavity 1200) having rounded edges. Bottom 1110 of first cavity 1100 has a plurality of ridges 1195. Each of plurality of ridges 1195 has a height that is less than a height of first cavity 1100.

Dish 1000 comprises a first foot 1600 and a second foot 1700. First foot 1600 is an extension of a third edge 1140 of first cavity 1100. A junction 1220 between first foot 1600 and fourth edge 1150 of first cavity 1100 can be rounded. A base 1640 of first foot 1600 can have a planar surface. Second foot 1700 is an extension of a second edge 1230 of second cavity 1200. A junction 1720 between second foot 1700 and fourth edge 1250 of second cavity 1200 can be rounded. A base 1740 of second foot 1700 can have a planar surface.

In certain exemplary embodiments, exterior corners of dish 1000 are rounded.

In certain exemplary embodiments, exterior corners of dish 1000 are beveled.

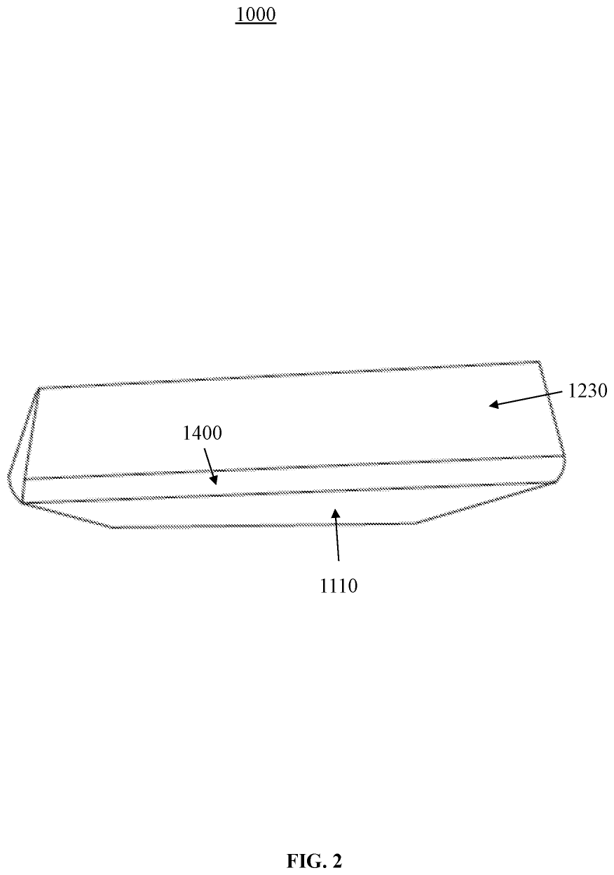

FIG. 2 is a perspective view of dish 1000, which illustrates a beveled edge 1400 between bottom 1110 and second edge 1230. Second edge 1230 can have embedded stones, which can improve aesthetics of the dish.

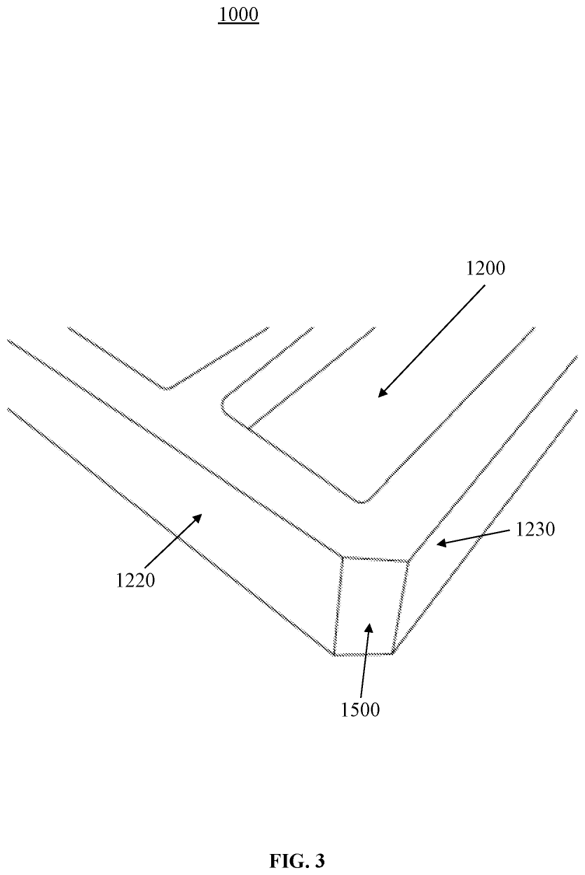

FIG. 3 is a perspective view of a portion of dish 1000, which illustrates a beveled corner 1500 first edge 1220, second edge 1230

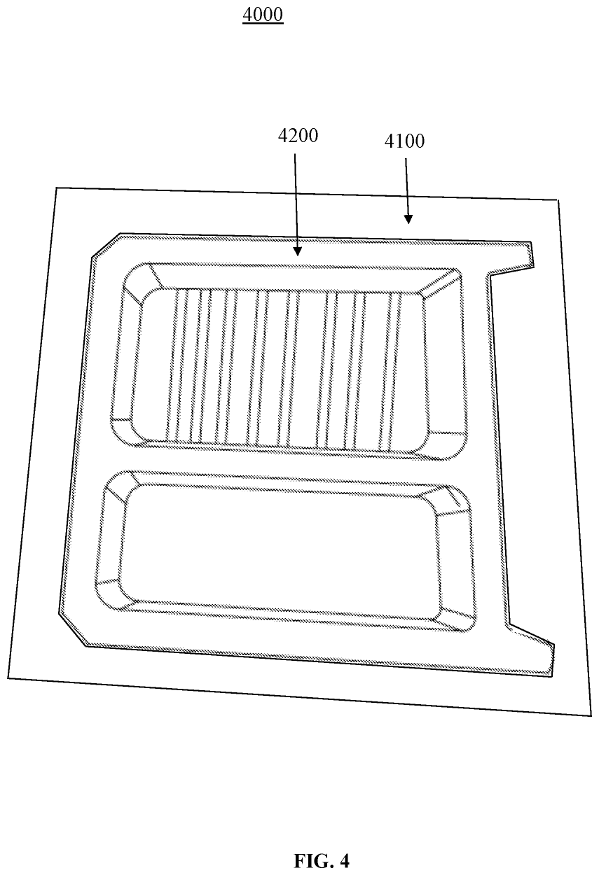

FIG. 4 is a perspective view of an exemplary embodiment of a system 4000, which comprises a mold 4100 and a dish 4200.

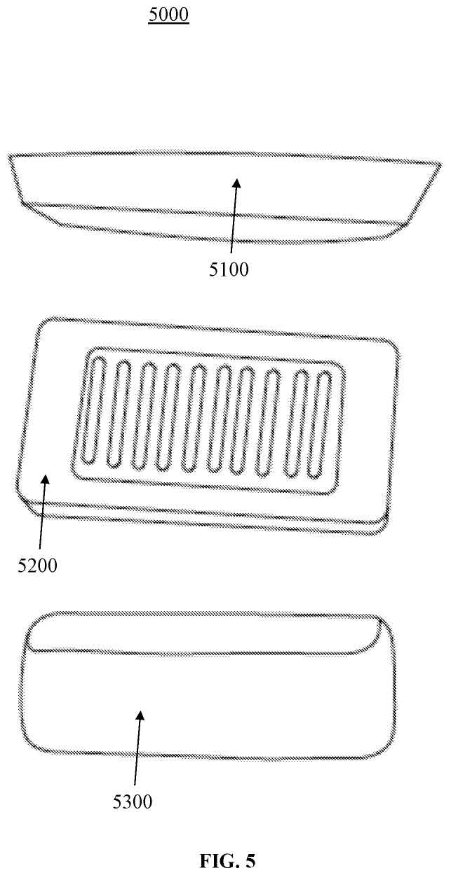

FIG. 5 is a perspective view of an exemplary embodiment of a system 5000, which illustrates a set of object negatives that can be used in the making of cavities of cast dishes. For example, system 5000 comprises a first object negative 5100, a second object negative 5200, and a third object negative 5300. First object negative 5200 and/or third object negative 5300 can be pressed into a castable material to form a cavity in a dish (see, e.g., second cavity 1200 of FIG. 1). Second object negative 5200 can be pressed into a castable material to form a cavity in a dish that comprises ridges (e.g., first cavity 1200 of FIG. 1). First object negative 5100, a second object negative 5200, and third object negative 5300 can comprise silicon rubber or a comparable material.

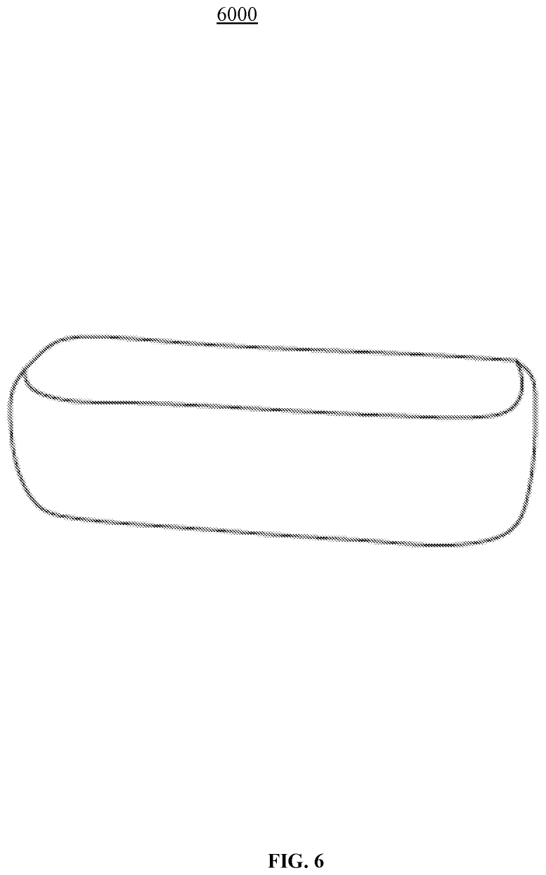

FIG. 6 is a perspective view of an exemplary embodiment of an object negative 6000. Object negative 6000 can be pressed into a castable material to form a cavity in a dish (see, e.g., second cavity 1200 of FIG. 1). Object negative 6000 can comprise silicon rubber or a comparable material.

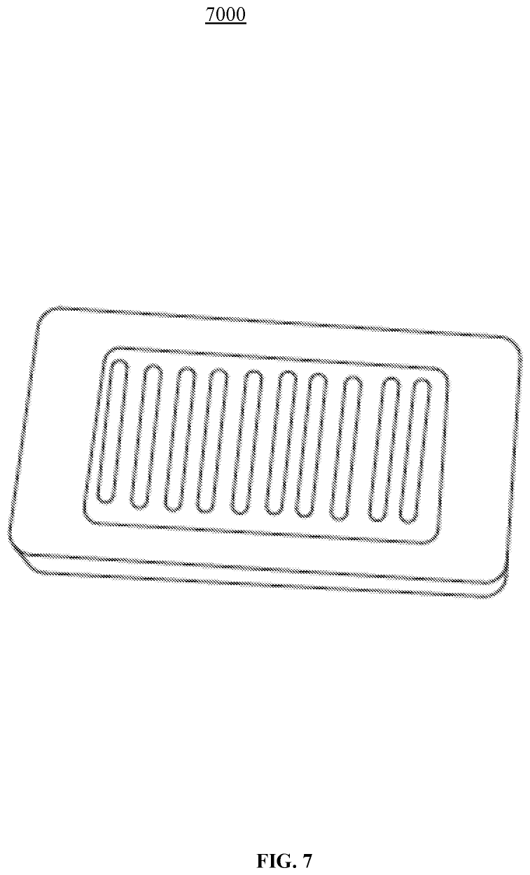

FIG. 7 is a perspective view of an exemplary embodiment of an object negative 7000. Object negative 7000 can be pressed into a castable material to form a cavity in a dish that comprises ridges (e.g., first cavity 1200 of FIG. 1). Object negative 7000 can comprise silicon rubber or a comparable material.

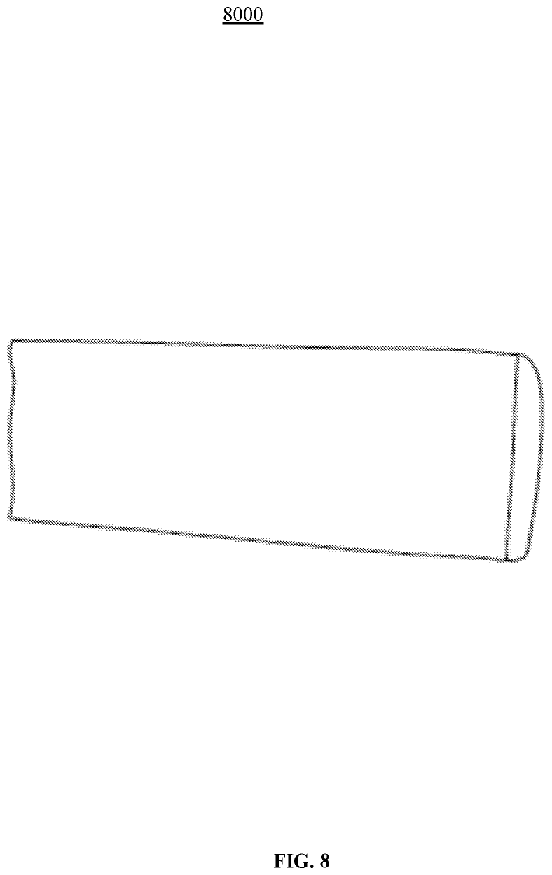

FIG. 8 is a perspective view of an exemplary embodiment of an object negative 8000. Object negative 8000 can be pressed into a castable material to form a cavity in a dish (see, e.g., second cavity 1200 of FIG. 1). Object negative 8000 can comprise silicon rubber or a comparable material.

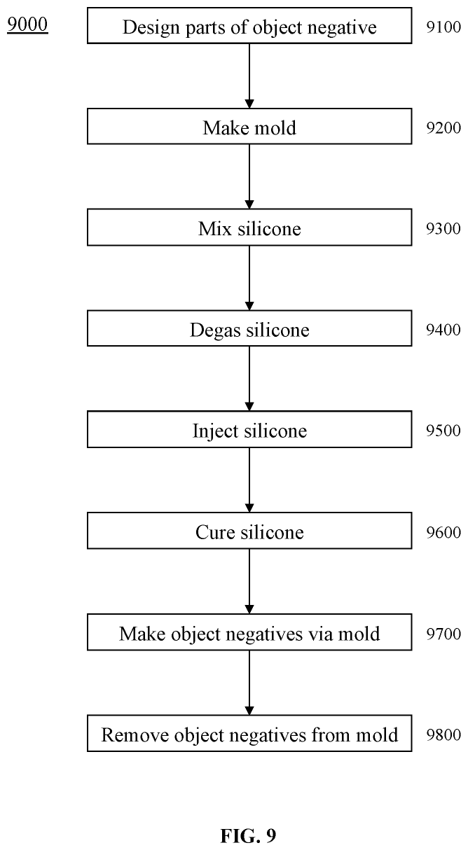

FIG. 9 is a flowchart of an exemplary embodiment of a method 9000. At activity 9100 one or more object negatives can be designed. Certain exemplary embodiments provide, such as via computer aided design, designing parts of a non-metal object.

At activity 9200 parts of a mold can be made. Certain exemplary embodiments provide for making a mold for a dish mold and/or object negatives via at least one of a 3-D printer, a machine tool that utilizes computer numerical control to create a silicone mold.

At activity 9300, silicone can be mixed, which can be used in the mold. At activity 9400, the silicone can be degassed, such as under vacuum. At activity 9500, the silicone can be injected in the mold. At activity 9600, the silicone can be cured in the mold. At activity 9700, the dish mold and/or object negatives can be made via a mold. For example, the object negatives can be made with silicone. One of the object negatives can have a ridged surface. In certain exemplary embodiments, the ridged surface can be made via a row of nails. At activity 9800, object negatives can be removed from the mold.

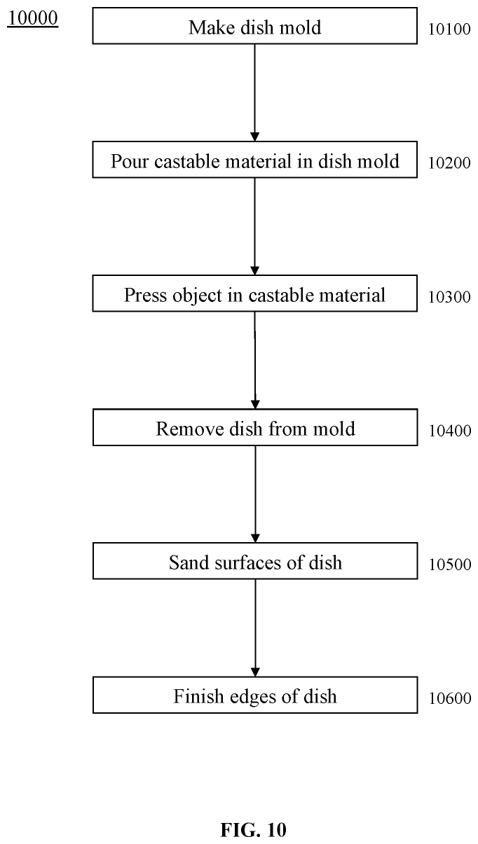

FIG. 10 is a flowchart of an exemplary embodiment of a method 10000. At activity 10100 a dish mold can be made. In certain exemplary embodiments, the dish mold can be cast or carved from a material such as a plastic material or wood. At activity 10200, a castable material can be poured into the dish mold to form a dish. The castable material can comprise sand and cement (e.g., white sand and white cement). In certain exemplary embodiments, small stones can be added to the castable material to improve a finished appearance of the dish.

At activity 10300, one or more objects can be pressed into the castable material. For example, a first object can be pressed into the castable material thereby forming a first cavity in the dish. A second object can be pressed into the castable material thereby forming a second cavity in the dish.

At activity 10400, the dish is removed from the mold. At activity 10500, surfaces of the dish are sanded. In certain exemplary embodiments an abrasive pad can be used to sand and/or condition surfaces of the dish.

At activity 10500, edges of the dish are finished. In certain exemplary embodiments, the dish comprises a surface of a washboard (e.g., in the first cavity of the dish).

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
bevel—to create a slanted surface, wherein the surface is slanted at less than a right angle.
bottom—a lowermost portion of something when oriented in an installed position.
can—is capable of, in at least some embodiments.
cast—to receive form in a mold.
cause—to produce an effect.
cavity—a hollow space in an object.
comprising—including but not limited to.
configure—to make suitable or fit for a specific use or situation.
connect—to join or fasten together.
constructed to—made to and/or designed to.
convert—to transform, adapt, and/or change.
corner—a junction at which two converging surfaces meet.
couple—to physically join in some fashion.
coupleable—capable of being joined, connected, and/or linked together.
create—to bring into being.
define—to establish the outline, form, or structure of
device—a machine, manufacture, and/or collection thereof.
dish—an open, container capable of holding something.
edge—an outside limit of an object, area, or surface.
extension—a component that projects from a device.
exterior—being on an outer side.
finish—to smooth, sand, machine, and/or condition a surface.
foot—a part of an object that projects from a surface of the object.
form—to create.
height—a dimension along a direction that is substantially perpendicular to the ground.
install—to connect or set in position and prepare for use.
junction—a place of meeting.
material—something used in making items.
may—is allowed and/or permitted to, in at least some embodiments.
method—a process, procedure, and/or collection of related activities for accomplishing something.
mold—(n) a cavity in which a substance is shaped; (v) to shape a substance via pouring the substance into a cavity.
object—a tangible thing.
planar—having a substantially flat surface.
plurality—the state of being plural and/or more than one.
pour—to send a fluid flowing.
predetermined—established in advance.
press—to compress or squeeze.
provide—to furnish, supply, give, and/or make available.
receive—to get, take, acquire, and/or obtain.
remove—to move from a position.
repeatedly—again and again; repetitively.
request—to express a desire for and/or ask for.
ridge—a part projecting from a surface of an object.
rounded—made to be curved.
sand—to smooth or polish with an abrasive such as sandpaper.
select—to make a choice or selection from alternatives.
set—a related plurality.
store—to place, hold, and/or retain.
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
transmit—to send, provide, furnish, and/or supply.
via—by way of and/or utilizing.
washboard—a surface that comprises ridges.
weight—a value indicative of importance.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
pouring a castable material into a mold to form a dish;
pressing a first object into the castable material thereby forming a first cavity in the dish; and
pressing a second object into the castable material thereby forming a second cavity in the dish.

2. The method of claim 1, further comprising:
removing the dish from the mold.

3. The method of claim 1, further comprising:
removing the dish from the mold; and
finishing edges of the dish.

4. The method of claim 1, further comprising:
sanding surfaces of the dish.

5. The method of claim 1, wherein:
the dish comprises a surface of a washboard.

6. A device comprising:
a dish, the dish defining a first cavity and a second cavity, each of the first cavity and the second cavity having a bottom and four edges, a junction between the bottom and each four edges of each of the first cavity and the second cavity having a rounded surface, each junction between each the four edges of each of the first cavity and the second cavity having rounded edges, the bottom of the first cavity having a plurality of ridges, each of the plurality of ridges having a height that is less than a height of the first cavity, the dish comprising a first foot and a second foot, wherein:
the first foot is an extension of a first edge of the first cavity, a junction between the first foot and a second edge of the first cavity being rounded, a base of the first foot having a planar surface; and
the second foot is an extension of a first edge of the second cavity, a junction between the second foot and a second edge of the second cavity being rounded, a base of the second foot having a planar surface.

7. The device of claim 6, wherein:
exterior corners of the dish are rounded.

8. The device of claim 6, wherein:
exterior corners of the dish are beveled.
